(19) United States
(12) Patent Application Publication
(10) Pub. No.: US 2003/0227453 A1
(43) Pub. Date: Dec. 11, 2003

(54) Method, system and computer program product for automatically creating an animated 3-D scenario from human position and path data

(76) Inventors: Klaus-Peter Beier, Ann Arbor, MI (US); Denis Kalkofen, Tangermuende (DE); Lubomira A. Dontcheva, Ann Arbor, MI (US); Lars Schumann, Ann Arbor, MI (US); Lars Bjorn Jensen, Ann Arbor, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 10/408,884

(22) Filed: Apr. 8, 2003

Related U.S. Application Data
(60) Provisional application No. 60/371,028, filed on Apr. 9, 2002.

(51) Int. Cl. G09G 5/00; G06T 15/70; G06T 13/00; G06T 15/00; A63B 69/00; G09B 19/00; G09B 9/00

(52) U.S. Cl. 345/419; 345/757; 434/247; 345/473

(57) ABSTRACT

A method, system and computer program product for automatically creating animated 3-D scenarios from human position and path data are provided. The method and system may include immersive and non-immersive virtual reality technologies for the training and mental conditioning of trainees such as football players with a focus on visual perception skills. The method and system may include a unique combination of commercially available hardware, specially developed software, data sets, and data libraries, as well as commercially available software packages.

### CROSS-REFERENCE TO RELATED APPLICATION

This application claims the benefit of U.S. provisional application Serial No. 60/371,028, filed Apr. 9, 2002, entitled “Virtual Football Trainer,” which is hereby incorporated in its entirety by reference herein.

### BACKGROUND OF THE INVENTION

1. Field of the Invention

This invention relates to methods, systems and computer program products for automatically creating animated 3-D scenarios from human position and path data.

2. Background Art

Athletes in team sports such as football are currently trained for visual perception on the field and/or by studying playbooks and video recordings.

The company B.W. Software offers PlayMaker, a widely used drawing program for diagraming plays used by football coaches to create playbooks. This is only a two-dimensional tool with no capabilities for creating three-dimensional animations for virtual reality.

The product SoccerMaster from AniSports, a Korean-based company, tracks real soccer players on the field via video cameras, and creates animated players from this information for computer generated replays. Immersive virtual reality is not used.

A Japanese paper entitled “VR American Football Simulator with Cylindrical Screen” and presented at the Second International Conference on Virtual Worlds in Paris (July 2000) outlines similar concepts, but on a much reduced level. The Cylindrical Screen is a custom-made visualization system and not comparable to a CAVE. The players move like chess figures and are not animated. The papers seems to be more a proposal than the description of an existing system.

At the MIT Media Laboratory, a project entitled “Computers Watching Football” is developing methods for tracking football players directly from real video. The goal is to use the recovered player trajectories as input to an automatic play labeling system. This technology is of interest for creating virtual plays from video capture.

The computer and video game industry has developed many football applications during the past years. One such product is Madden 2002.

CAVE (Computer Automatic Virtual Environment) is an immersive virtual reality system that uses projectors to display images on three or four walls and the floor, as shown in FIG. 1. Special glasses make everything appear as 3-D images and also track the path of the user's vision. CAVE was the first virtual reality system to let multiple users participate in the experience simultaneously. It was developed by the Electronic Visualization Laboratory (EVL) at the University of Illinois in the early 1990s.

U.S. Pat. No. 5,890,906 discloses a method of instruction and simulated training and competitive play or entertainment in an activity that couples cognitive and motor functions, in particular, the playing of the game of hockey. The invention includes a computer used to view and to control images of hockey players on a computer screen. An image of a hockey player controlled by the user is juxtaposed to or superimposed upon the image of an instructive, ideal or master hockey player(s). The user manipulates the controlled image of a hockey player in an effort to approximate the movements of the instructive or ideal player via an input device such as a keyboard, joystick, or virtual reality device. The invention also includes means by which the user's performance in approximating the instructive or ideal player may be measured. The user can also control an image of a hockey player on the computer screen so that the image engages in performing offensive and defensive drills in opposition to an ideal or another opponent or team.

U.S. Pat. Nos. 6,164,973 and 6,183,259 provide users with control functions for “user controllable images” to simulate physical movements. Although it is not really clear, it seems that the controllable images are pre-recorded images (videos) that are being called upon by the user (directly or indirectly). The images are not created as needed. In the ice skating embodiment of the invention, the user deals with one ice skater at a time.

U.S. Pat. No. 6,181,343 permits navigation through a virtual environment controlled by a user's gestures captured by video cameras.

U.S. Pat. No. 6,195,104 “constructs” three-dimensional images of the user based on video-capture of the real user.

### SUMMARY OF THE INVENTION

An object of the present invention is to provide an improved method, system and computer program product for automatically creating an animated 3-D scenario from human position and path data.

In carrying out the above object and other objects of the present invention, a method for creating an animated 3-D scenario is provided. The method includes receiving data which represent humans and positions and paths of the humans. The method further includes automatically creating an animated 3-D scenario including 3-D animated virtual humans moving along virtual paths based on the data.

The scenario may be a play and the virtual humans may be virtual players such as virtual football players.

The data may represent a 2-D chart such as a play chart.

The method may further include editing the data to obtain edited data. The step of creating may be based on the edited data and may include the step of determining interactions between the virtual humans based on the paths.

The step of creating may further include determining virtual motions for the virtual humans involved in the determined interactions.

The method may further include creating a virtual environment and simulating the animated 3-D scenario in the virtual environment.

The method may further include controlling the animated 3-D scenario in the virtual environment.

The step of controlling may include the step of controlling a view point of a real human viewing the animated 3-D scenario.

The method may further include automatically creating a file containing the animated 3-D scenario. The file may be a VRML (i.e., Virtual Reality Modeling Language) file.

The method may further include distributing the file. The step of distributing may be performed over a computer network.

The virtual environment may be at least partially immersive or may be non-immersive.

Further in carrying out the above object and other objects of the present invention, a system is provided for creating an animated 3-D scenario. The system includes means for receiving data which represent humans and positions and paths of the humans. The system further includes means for automatically creating an animated 3-D scenario including 3-D animated virtual humans moving along virtual paths based on the data.

The system may further include means for editing the data to obtain edited data. The means for creating may create the animated 3-D scenario based on the edited data.

The means for creating may further include means for determining interactions between the virtual humans based on the paths.

The means for creating may still further include means for determining virtual motions for the virtual humans involved in the determined interactions.

The system may further include means for creating a virtual environment and means for simulating the animated 3-D scenario in the virtual environment.

The system may further include means for controlling the animated 3-D scenario in the virtual environment.

The means for controlling may control a view point of a real human viewing the animated 3-D scenario.

The system may further include means for automatically creating a file such as a VRML file containing the animated 3-D scenario.

The system may further include means for distributing the file. The means for distributing may be a computer network.

Still further in carrying out the above object and other objects of the present invention, a computer program product is provided comprising a computer readable medium, having thereon computer program code means, when the program is loaded, to make the computer execute procedure: to receive data which represent humans and positions and paths of the humans; and to automatically create an animated 3-D scenario including 3-D animated virtual humans moving along virtual paths based on the data.

The code means may further make the computer execute procedure to edit the data to obtain edited data. The animated 3-D scenario may be automatically created based on the edited data.

The code means may further make the computer execute procedure to determine interactions between the virtual humans based on the paths.

The code means may further make the computer execute procedure to determine virtual motions for the virtual humans involved in the determined interactions.

The code means may further make the computer execute procedure to create a virtual environment and to simulate the animated 3-D scenario in the virtual environment.

The code means may further make the computer execute procedure to control the animated 3-D scenario in the virtual environment.

The code means may further make the computer execute procedure to control a view point of a real human viewing the animated 3-D scenario.

The code means may further make the computer execute procedure to automatically create a file such as a VRML file containing the animated 3-D scenario.

The code means may further make the computer execute procedure to distribute the file. The distributing may be performed over a computer network.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a schematic perspective view of a prior art CAVE system;

FIG. 2 is a block diagram flow chart illustrating the overall software structure of one embodiment of the present invention;

FIG. 3 is a schematic view of a screen showing a user interface of a chart editor program;

FIG. 4a is a schematic view of an internal skeleton of an animated player;

FIG. 4b is a portion of a screen shot of a geometry shell of a player corresponding to the internal skeleton of FIG. 4a; and

FIG. 5 is a screen showing how a play can be viewed with a Screen Viewer Program.

### DETAILED DESCRIPTION OF THE PREFERRED EMBODIMENTS

Overview of One Embodiment of the Invention

An objective of one embodiment of the present invention is to provide a method, system and computer program product for automatically creating an animated 3-D scenario to train football players with respect to visual perception, correct reading of play situations, sharpening of cognitive skills, fast reaction to the movement of other players, understanding and memorization of three-dimensional play scenarios, and improvement of decision making skills.

The objective may be achieved by placing a football player (the trainee) into a fully immersive, virtual environment consisting of life-size, animated virtual players on a virtual football field inside a virtual stadium. The environment is computer-generated and presented realistically in full scale and in stereo. The trainer (a football coach) can call up a specific play from a library of predefined plays and execute this play in virtual reality. The virtual players from both teams will perform this play (using animation technologies) in real-time. The trainee can observe the play from any viewpoint, specifically from any position on the field and can walk around on the virtual field as well as fly around. In addition, the trainee can assume the role of any selected virtual player and move automatically with this player as the play unfolds.

Trainer and trainee can view and discuss a play, move to any position on or above the field, freeze a play animation at any point in time, execute the play in real-time or in slow motion, and rewind and forward the animation. The trainer can evaluate the reaction of the trainee to any given play situation.

To achieve an optimal degree of immersion, one embodiment of the invention uses a CAVE (Computer Automatic Virtual Environment) system, currently the most advanced technology for immersive virtual reality. But other immersive virtual reality systems like a Head-Mounted Display, a BOOM (Binocular Omni-Orientation Monitor) device, large screen projection systems, and similar technologies may be used as well, as long as full scale representation, stereo and/or motion parallax, and head-referenced viewing in real-time are supported.

Since immersive virtual reality systems are expensive and not always readily available, another embodiment of the invention includes a non-immersive, virtual reality alternative as a low-cost solution. In this alternative, an animated 3-D play can be viewed on the screen of a desktop or laptop computer. Full scale representation is no longer available, but the user can observe the play from any viewpoint and can assume the role of a selected player as in the immersive embodiment of the invention. In addition, the files containing the descriptions of complete plays can be exchanged over the Internet using a 3-D Interchange File format (i.e., VRML).

The non-immersive alternative can be enhanced by providing a semi-immersive viewing mode. Various technologies exist that allow for stereo viewing and/or motion parallax (in response to the viewer's head movements) while watching a play on a computer's display screen.

One embodiment of the invention includes tools that enable a coach to create new plays or variations of existing plays and add these plays to a Play Library. The creation and modification of plays requires only a laptop or desktop computer and the process is similar to the common practice of creating diagrams for playbooks. The resulting two-dimensional definition of a play is converted by the embodiment of the invention into three-dimensional animations automatically using Artificial Intelligence (AI) algorithms.

Plays from the Play Library can be converted for viewing with immersive as well as non-immersive technologies. A coach may use an immersive CAVE system to train a quarterback and, at the same time, distribute plays over the Internet to other team members for viewing and studying the plays on a laptop or desktop computer at home. The plays can also be distributed using portable storage devices like disks, CDs, and other media.

One embodiment of the invention has been designed to allow for maximum flexibility. Not only plays but also other scenarios like the run from the tunnel onto the field or the performance of the marching band on the field can be simulated. Referees can be trained as well with the embodiment of the invention. The concept can be expanded for athlete training in other team sports like soccer, ice hockey, etc.

Furthermore, the concept is also applicable to combat simulations, squad team training for dangerous missions, police deployment or simulation of accidents that involve people having the same problem. These virtual humans can be animated according to a given simulation script or scenario with an embodiment of the present invention.

Hardware Components of One Embodiment of the Invention

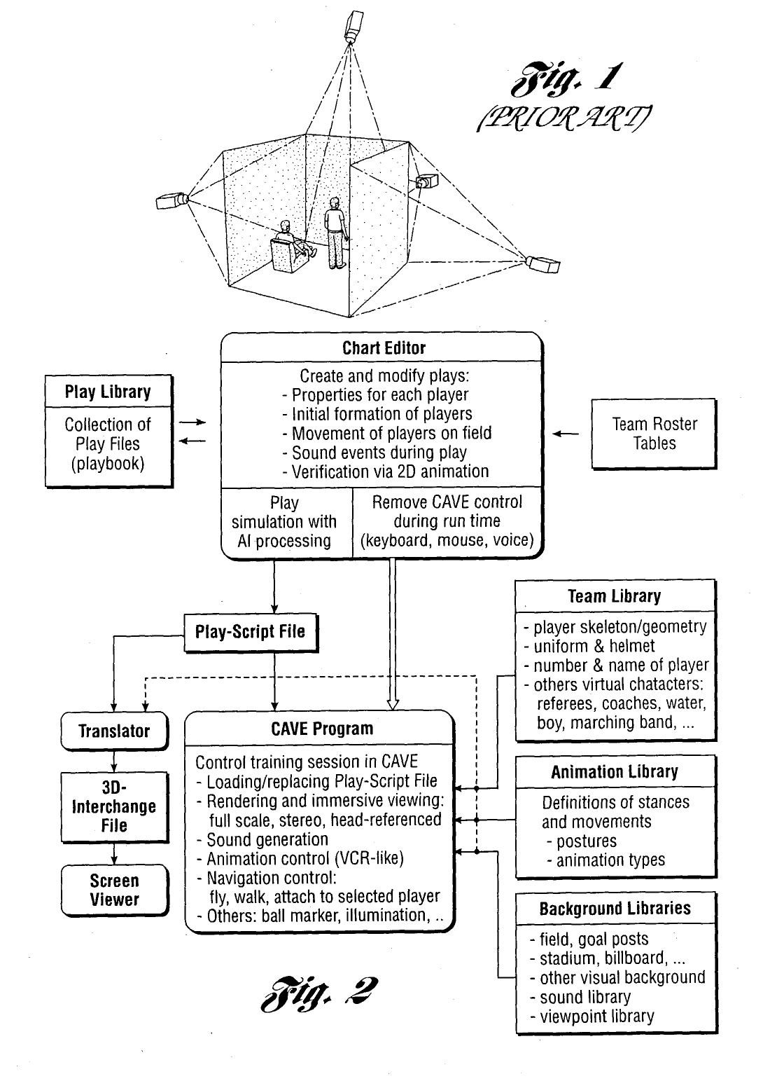

The CAVE is a room-sized cube (typically 10×10×10 feet) consisting of three walls and a floor (see FIG. 1). These four surfaces serve as projection screens for computer generated stereo images. The projectors are located outside the CAVE and project the computer generated views of the virtual environment for the left and the right eye in a rapid, alternating sequence. The user (trainee) entering the CAVE wears lightweight LCD shutter glasses that block the right and left eye in synchrony with the projection sequence, thereby ensuring that the left eye only sees the image generated for the left eye and the right eye only sees the image generated for the right eye. The human brain processes the binocular disparity (difference between left eye and right eye view) and creates the perception of stereoscopic vision.

A motion tracker attached to the user's shutter glasses continuously measures the position and orientation (six degrees of freedom) of the user's head. These measurements are used by the viewing software for the correct, real-time calculation of the stereo images projected on the four surfaces. A hand-held wand device with buttons, joystick, and an attached second motion tracker allows for control of and navigation through the virtual environment.

Other hardware elements of the CAVE include a sound system, networked desktop computers that control the motion trackers, and an expensive, high-end graphics computer that generates the stereo images in real-time and executes all calculations and control function required by the embodiment of the invention during immersive viewing. In the following description, this computer is called the CAVE computer.

As previously mentioned, the CAVE was developed by the Electronic Visualization Laboratory (EVL) at the University of Illinois at Chicago and first demonstrated at the SIGGRAPH computer graphics conference in 1992. It became a commercial product in 1995 and is currently marketed by Fakespace Systems and other companies.

For one embodiment of the present invention, CAVE variations with four walls and floor (five projection surfaces) as well as with four walls, floor, and ceiling (six projection surfaces) may be used as well. In addition, other immersive systems (Head-Mounted Display, BOOM device, large screen projection systems, etc.) can be deployed. In the following, all immersive functions of the VFT (i.e., Virtual Football Trainer) will be described with respect to the CAVE. However, the same functions can be implemented for any other immersive system.

One embodiment of the present invention uses a standard laptop computer for the creation and modification of plays as well as for the control of the CAVE application. For the latter, the laptop is connected via a network link to the CAVE computer. The trainer uses the laptop to control a training session in the CAVE. The laptop can be replaced by a desktop computer.

In addition to the laptop computer, a voice recognition system can be used to process spoken commands from the trainer as well as from the trainee. These spoken commands are converted into control instructions for the CAVE application. The voice recognition software runs on the laptop and the commands are transferred to the CAVE application as described above.

For the non-immersive embodiment of the present invention, a modern desktop or laptop computer with a graphics accelerator board is recommended. An Internet connection is also recommended. Technologies for the enhanced, semi-immersive viewing mode include, for example, shutter glasses, motion trackers attached to the viewer's head, specialized display screens, and other techniques. In the following paragraphs, all descriptions of the non-immersive embodiment of the present invention apply accordingly to the semi-immersive viewing mode.

Software Components of One Embodiment of the Invention

FIG. 2 illustrates the overall software structure of one embodiment of the invention. A Chart Editor program runs on a laptop computer and allows for the creation and modification of plays that can be stored in a Play Library. Once a play is defined, the Chart Editor creates a Play-Script File that is transferred to the CAVE computer and used by the CAVE Program. The CAVE Program uses several libraries (Team Library, Animation Library, and Background Libraries) to create the immersive representation of the play. Execution of the play animation in the CAVE as well as navigation are controlled remotely from the laptop through special functions of the Chart Editor.

The Play-Script File can be processed by a Translator and converted into a 3D-Interchange File for possible distribution over the Internet and for use by a Screen Viewer program on a laptop or desktop computer.

Chart Editor

The functions of the Chart Editor program can be divided into three major categories:

Play Creation and Modification;

Play Simulation and AI Processing; and

Remote CAVE Control.

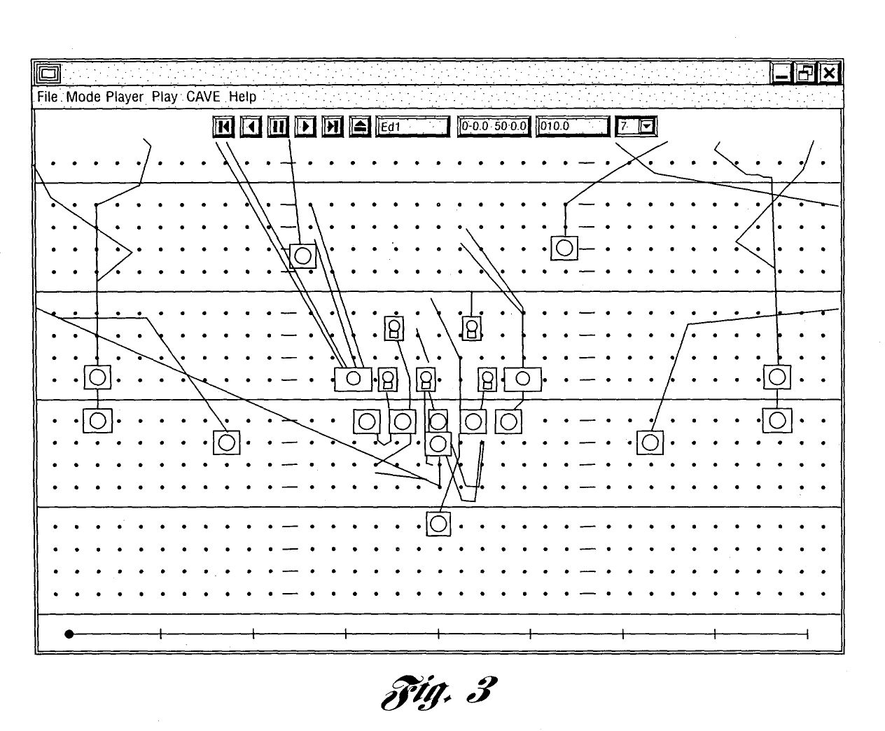

The Chart Editor uses an interactive graphics user interface with pull-down menus and direct graphics input via the program's window. This window shows a top view of the football field with yard lines and players represented by symbols, as illustrated in FIG. 3. An interactive time axis (at the bottom) assists with animation control and fine-tuning of the player's movements.

Play Creation and Modification

For each play, overall properties such as the names of the offense and defense team, the start time, the duration time, whether the play is a passing play or not, whether the play is successful for the offense or not, and other parameters can be specified.

Players are represented in the Chart Editor's window by color-coded symbols. For each player, several inherent properties can be defined, like team name, player's number, player's name, play position (e.g., Quarterback, Wide Receiver, etc.), as well as player's weight and height. This information can be directly obtained by pointing into a table containing the team roster. Players can be added or deleted.

For each player, a moving path is defined usually starting from the initial formation at the line of scrimmage. Consecutive control points are entered to define a player's path. For each control point, the player's location on the field, the time, the orientation angle (direction the player is facing), a pose, the interpolation method for the path to the next control point, and a ball-possession flag are stored. Each control point represents the state of the player at a certain point in time. Several edit functions allows to modify the control point characteristics. This “rich control point concept” is an important part of the overall design of the embodiment of the invention.

For the subsequent three-dimensional animation of the play in immersive or non-immersive virtual reality, the control point information “pose” determines the animation type to be used (e.g., standing, running, falling, tackling, pushing, throwing, catching, and others). If the user of the Chart Editor does not specify “pose,” the value default is assumed and later replaced by an appropriate pose during AI Processing. In a similar way, orientation angles and path interpolation method can be determined automatically.

A VCR-like control panel allows for the verification of the movements of the players in the Chart Editor's window. While a marker on the time axis at the bottom of the window indicates the running time, the player's symbols move according to the specifications defined for the control points. Movements between the control points are interpolated using either a linear or a higher order interpolation method to determine a straight or curved path, respectively. The resulting 2-D animation allows for play verification as it unfolds in time and assists in fine-tuning the play.

Several additional control options of the Chart Editor allows the user to translate the entire play to any position on the field, to zoom in and out, to center the play, and to turn the display of certain items on and off (e.g., grid lines, moving path, control point labels, others).

Sound events can be defined by either specifying the start of a selected sound bite along the time axis or by connecting a sound event with any of the control points. In addition, the sound's location of origin and an amplitude factor (sound volume) can be specified. The sound location can be connected to the location of a selected player if this player is assumed to be the source of the sound.

A play containing all the above information can be stored as a Play File in the Play Library. Any play from the Play Library can be loaded into the Chart Editor for verification and/or modification. The VFT provides a standard set of Play Files in the Play Library that can be used as a starting point for the creation of new plays.

In a similar way, positions and movements of additional characters like referees, coaches on the side line, or cheerleaders can be modeled. These characters may also serve as sound sources. Ultimately, all players and additional characters can be replaced, for example, by the members of a marching band for the design and animated simulation of marching band formations.

Play Simulation and AI Processing

A single command of the Chart Editor invokes an automatic process called “Play Simulation and AI Processing” that converts the currently loaded Play File into a Play-Script File for use by the CAVE Program and the Translator (see FIG. 2).

In this process, the play is divided into small time steps, the path for each player is interpolated, missing orientation angles are calculated, and the entire play is simulated by an internal algorithm (not visible to the user). The AI (Artificial Intelligence) part of the algorithm replaces all default pose information by suitable animation types. By calculating the speed of a player between two given control points, the animation type like walking, running at different speeds, or sprinting can be determined and animation factors that fine-tune a selected animation type to a given speed (to avoid sliding) are computed. In a similar way, weight and height of a player influence motion characteristics and result in appropriate selection of animation types and animation factors.

For each time step, all players are examined for interactions and possible collision with each other. Accordingly, AI Processing selects the appropriate pose and animation type to be used for the 3D animation of a tackle or a similar collision event. The AI algorithm is based on a principle that uses reactive behavior to control a character's behavior. In this context, a predefined set of rules determines what a character should do in a given situation. The decision making algorithm uses all information available in the Play File. For example, if a play is marked as successful for the offense, the play may end with automatically generated jumps or dances of the offense team accompanied by a sound bite of the team's hymn.

The play simulation also determines the passing or throwing of the ball and calculates the trajectory for the ball's movement. Matching animation types for passing, throwing, and catching the ball are inserted by the AI algorithm.

The generated Play-Script File is similar to the original Play File, but contains significantly more information with a denser time grid of control points, with all animation types, animation factors, ball trajectories, sound events, etc.

As mentioned before, this part of the embodiment of the invention runs in the background, but is of central importance for a practical use of the embodiment. A coach can create a play by specifying a minimum amount of information. Basically, the coach uses the Chart Editor to place the players on the field and define the path for their movements. The complex details required for a three-dimensional animation in virtual reality are generated automatically. For special situations, the user of the Chart Editor program can overwrite any information generated by AI Processing.

Remote CAVE Control

The Play-Script File created in the previous step by the Chart Editor is transmitted to the CAVE Program for a training session in immersive virtual reality. The transmission over a local network and the processing (initializing a new play) by the CAVE Program requires only a few seconds. Using the network, the coach can continue using the Chart Editor on the same laptop by invoking a different set of functions from a pull-down menu that allow to control the training session in the CAVE remotely from the laptop. This has not only practical advantages, but also permits the coach to switch back to edit mode, modify a play slightly, and have it immediately ready for execution in the CAVE. A special update function only transmits changes of a play to the CAVE and requires minimal transmission and initialization time.

Commands from the laptop to the CAVE are entered on the laptop using the keyboard or pull-down menus. Alternatively, a voice recognition system can be deployed. Trainer and trainee wear lapel microphones and speak the commands. The CAVE control part of the Chart Editor converts these spoken commands into the equivalent keyboard or pull-down menu functions and transmits the resulting control instructions to the CAVE.

The voice recognition alternative not only provides faster CAVE control and flexibility for moving around, it also lets the trainee (player) participate directly in CAVE control and allows to record and time the player's verbal reactions to a play. In addition, a player wishing to review certain plays in the CAVE can do this without the presence of a trainer. While freely moving around in the CAVE, the player can execute any control function over the voice recognition system.

Since all CAVE control functions are executed by the CAVE Program, they are described in more detail hereinbelow.

CAVE Program

The CAVE Program reads the Play-Script File and loads all information required for the play from the Team Library, the Animation Library and the various Background Libraries (see FIG. 2). The main function of the CAVE Program is the generation and control of the immersive representation of the animated play including life-size and stereo display of virtual players (and other characters) and the surrounding virtual environment. In addition, head-referenced viewing by the trainee, navigation through the environment, generation of directional sound, communication with the Chart Editor program (remote CAVE control) and other functions are part of the CAVE Program. All functions are executed in real-time.

At the core of the CAVE Program is a so-called hierarchical scene graph, a data structure commonly used in computer graphics applications that describes all elements of a virtual scene and their relation to each other. These elements range from the stadium and the field all the way down to a yard line or a specific skeleton joint of an individual player. The CAVE Program contains computational algorithms for the creation and dynamic manipulation of the scene graph as well as for control and navigation.

The display of the scene graph's content in the CAVE, i.e., the calculation and rendering of the images projected on the CAVE's projection surfaces based on the current position and orientation of the viewer's head (head-referenced viewing) can be accomplished with the help of commercially available software packages.

The CAVE Program generates sound events using available software for the rendering of directional sound. A sound has a location of origin (sound source) and other characteristics. When played through a surrounding array of speakers, the sound is perceived as coming from the specified location.

Player Animation

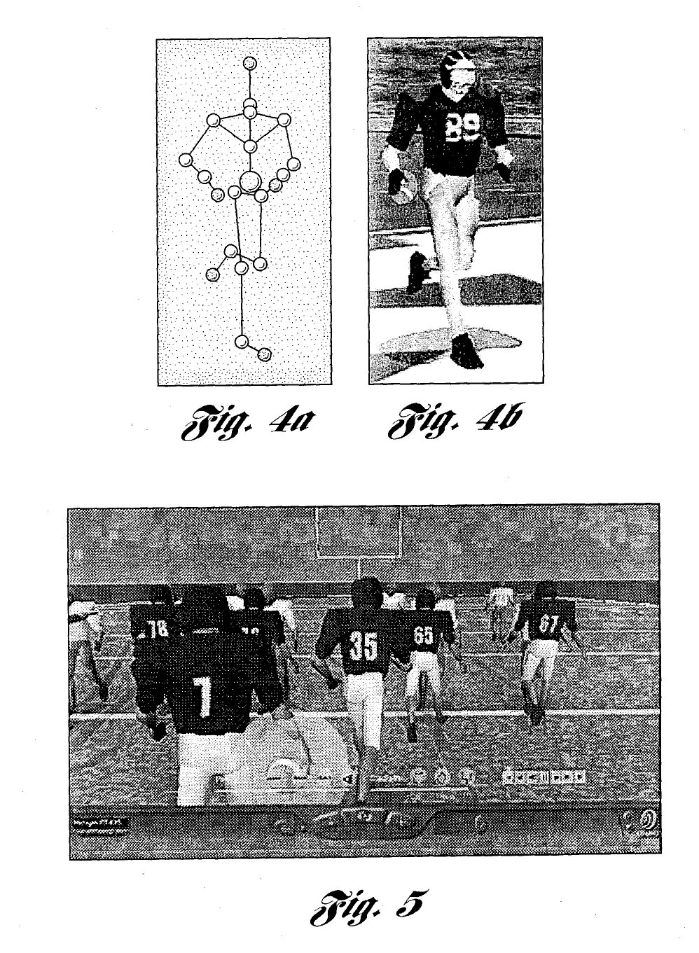

An important part of the scene graph are the data structures that describe each individual player. In order to generate realistically looking animated movements, the motions of a player are controlled by an internal skeleton, a hierarchical structure of joints and links derived from human anatomy (see FIG. 4a). The links are assumed to be rigid elements corresponding to the bones. The joints (yellow spheres in FIG. 4a) are the connecting points between the links and act like ball-and-socket connectors that allow for rotation at each joint. Up to three angles can be defined to specify the rotation at a joint.

The skeleton is enveloped by a three-dimensional geometry shell that represents the player's external shape (see FIG. 4b). The geometry is divided into segments with each segment corresponding to a specific link of the skeleton. A segment is in a fixed relation to its corresponding link, but the segment's geometry can be flexible, i.e., it can stretch or shrink during the animation. For each player, a basic skeleton and a basic geometry are adjusted for height and weight of the player and the geometry is enhanced with information from the Team Library (e.g., uniform, player's number, etc.). Ultimately, only the external geometry is rendered. The skeleton is never displayed (except for program testing), but is numerically embedded in the scene graph and in the algorithms that control the animation.

A player is animated by translating and rotating the entire skeleton relative to the field and, at the same time, by changing the angles at the joints. The Animation Library contains data sets that specify all required parameters for postures (static pose of a player) as well as for animation types (dynamic motions). An animation type data set describes a specific motion (e.g., walk, run, etc.) by the sequence of all angles at the joints and other parameters over a dense time grid. An animation type is actually a sequence of postures defined over a time grid.

The complete and often complex movement of a player during a play is created by combining (or chaining) several postures and animation types together. The postures and animation types to be used are specified in the Play-Script File and have been previously determined by Play Simulation and AI Processing. The CAVE Program applies the animation factors and, in addition, ensures smooth transitions between the chained sequence of postures and animation types. This smooth transition is obtained in one of the following ways:

By designing animation types that start or end with identical postures and, therefore, automatically connect in a smooth way;

By interpolating an animation between the last posture of the previous animation type and the first posture of the following animation type if both postures are slightly different; and

By inserting special very short animation types that contain the transition from one posture to another if both postures are significantly different.

CAVE Control Functions

Once the CAVE Program has been started, it can be remotely controlled by special functions from the Chart Editor program. The control commands are entered via keyboard, pull-down menu, or voice recognition system and are transmitted from the trainer's laptop over the network using suitable transmission protocols. During CAVE control, the player's positions and movements are always synchronized between CAVE and laptop, i.e., while the three-dimensional virtual players move in the CAVE, the player's symbols on the laptop move accordingly.

The following summarizes the CAVE Control functions.

Load/Update Play

Load a new play by reading (transmitting) a new Play-Script File.

Update an already loaded play that has been slightly modified in the Chart Editor program.

General Navigation

Set walk mode: viewer (trainee) is bound to the ground, can walk around, can cover larger distances using the joystick of the wand.

Set fly mode: viewer can fly around using the wand.

Select viewpoint: viewer is moved to center point of play (at line of scrimmage) or to any viewpoint defined in viewpoint library (e.g., side line, press box, tunnel, blimp, others).

Reset viewpoint: viewer is moved back to current viewpoint (after walking or flying around).

Rotate field: align field (with stadium and all players) with CAVE walls for viewing in the direction of offense, defense, or from either side line.

Lock/unlock navigation: disable/enable navigation using the wand.

Attached Navigation

Move viewer to the position of a selected player.

Attach viewer to a selected player: during animation, viewer will be moved with selected player using one of several attachment modes (e.g., follow player without stadium alignment, follow player with stadium alignment, move with player from inside helmet).

Control transparency of player: the transparency of the player to which the viewer is attached can be changed from 0% (fully visible) to 100% fully visible).

Animation Control (VCR Like)

Start play animation.

Stop/Resume play animation.

Forward/backwards control of play animation.

Jump to begin/end of play animation or to any point in time.

Control slow motion at different levels (including frame-to-frame control).

Additional Functions

Control ball marker: display/remove a transparent sphere around ball for better visibility.

Control sound: change sound volume, turn all sound on/off.

Play sound (start/stop): in addition to sound events specified in the Play-Script File, the trainer can call up any sound from the sound library at any point in time (independent from the Play-Script File).

Change environment: replace stadium, field, etc., or load other visual background (e.g., circling blimp in the sky) from Background Libraries.

Illumination and other effects: change lighting environment (daylight, floodlight), simulate fog, rain, snow.

Add viewpoint: add current position of viewer to viewpoint library or specify new viewpoint numerically.

Delete viewpoint: remove a viewpoint from viewpoint library.

Record sound: enable/disable the recording of the viewer's verbal reaction to a play animation with time stamp.

Translator, 3D-Interchange File and Screen Viewer

The Translator and the Screen Viewer (see FIG. 2) are two programs that allow for non-immersive viewing of an animated play. The Translator reads a Play-Script File and uses selected information from the Team Library, Animation Library, and Background Libraries to create a 3D-Interchange File. This file can be distributed over the Internet or via portable storage devices and is viewed on a laptop or desktop computer using the Screen Viewer program.

Translator and 3D-Interchange File

The Translator creates a simplified version of an animated play and stores this play in the 3D-Interchange File. The characteristics of this file are as follows:

The file can be transmitted over the Internet using the standards and transmission protocols of the World Wide Web.

The file contains a complete description of a three-dimensional play (all information required to run the play are either contained within this file or are accessible through this file via embedded WWW links).

The file size is small (compared to the size of the Play-Script File) and allows for fast transmission over the Internet.

The three-dimensional play animation can be executed on a desktop or laptop computer in real-time (the target computer is assumed to have significantly less computing power than the CAVE computer).

To create a 3D-Interchange File with small file size and real-time performance on the target computer, the Translator introduces several simplifications, some of them controllable by the user:

Simplified surrounding environment: for example, simplified stadium, symbolic stadium, or no stadium at all; simplified field; no other visual background.

Simplified skeleton and simplified geometry of players.

Reduced number of angles at the skeleton joints. Reduced number of joints for individual players (remove a joint if the angles at the joint don't change within margins during animation).

Simplified uniform, helmet, and number; no name of player.

Wider time grid for all animations. Compressed animation for individual players (remove key frames if animation does not change significantly over any given time period).

Simplified illumination (e.g., only daylight).

No sound (optional).

Elimination of players that are not essential (optional).

These simplifications are created by either extracting selected information from the library files, by using alternative library files that are specifically designed for use by the Translator, or by simply omitting elements specified in the Play-Script file.

The format of the 3D-Interchange File can be either a standardized 3D file format like VRML (Virtual Reality Modeling Language, ISO/IEC 14772-1:1997) or like X3D (eXtensible 3D, launched in August 2001, to be submitted to ISO) or can be a proprietary file format. A proprietary format can be designed specifically for the required functionality of the embodiment of the invention and, therefore, can be smaller and can be processed more efficiently by the Screen Viewer than a generic file format.

Screen Viewer

The Screen Viewer is a stand-alone program and/or a plug-in for a Web browser (like Netscape or Internet Explorer). The plug-in version provides a convenient, smooth transition between downloading a 3D-Interchange File over the Internet and handling the file by the Screen Viewer.

The Screen Viewer reads the 3D-Interchange File and starts with the creation of a perspective view from a default/initial viewpoint of the three-dimensional play scenario on the computer's monitor. Navigation and control functions are similar to the CAVE control functions and include general navigation, attached navigation, VCR-like animation control, and selected additional functions. All functions are mouse-controlled and available via a control panel and additional menu buttons that are superimposed on the viewing window, as illustrated in FIG. 5.

If the 3D-Interchange File complies with a standard 3D file format (e.g., VRML, X3D), an existing Screen Viewer can be used. These viewers provide a standard control panel for general navigation and allow for additional, application-specific control buttons to be defined within the 3D-Interchange File.

If the 3D-Interchange File uses a proprietary format, a proprietary Screen Viewer must be developed for this format. Such a proprietary Screen Viewer can be tailored to the functions of the embodiment of the invention and, therefore, can be significantly more efficient regarding real-time animation and frame rate as well as rendering quality. In addition, a proprietary 3D-Interchange File format and Screen Viewer is of high interest for a commercial version of the embodiment, since it can protect from unauthorized distribution and use of three-dimensional play animations.

Combined Use of Chart Editor and Screen Viewer

The low-cost, non-immersive alternative of the embodiment of the invention can also be used as a valuable aid during the process of creating new plays or modifying existing plays with the Chart Editor. While editing a play with the Chart Editor program on a laptop or desktop computer, a Play-Script File can be generated at any time and, after being processed by the Translator on the same computer, a simplified version of the play can be viewed in three dimensions in a separate window using the Screen Viewer. This allows to pre-view the three-dimensional version of the play and evaluate the results of the Play Simulation and AI Processing before using the immersive version in the CAVE. The sequence of Play Simulation and AI Processing, Play-Script File generation, translation into a 3D-Interchange File, and passing this file into the Screen Viewer can be fully automated and, therefore, invoked by a single Chart Editor command.

This concept of combined use of Chart Editor and Screen Viewer is of significant practical importance since a CAVE or other immersive viewing systems are not always readily available (e.g., reserved by other users or located at a distant place).

Using the Embodiment of the Invention with Large Screen Projection

The immersive use of the embodiment (e.g., in a CAVE) as well as the non-immersive alternative (using a computer's display screen) are basically designed for a single user (viewer or trainee). Even though the CAVE allows for several viewers (all equipped with shutter glasses), the stereo projection is only correct for the “leading” viewer, i.e., the viewer whose shutter glasses are equipped with a motion tracker. All other viewers see the virtual environment distorted.

For larger audiences (e.g., team meeting rooms, coach's conference room, presentation at conventions, etc.), a large screen projection system can be deployed to display and discuss a play. The embodiment of the invention supports these presentations at different levels.

While viewing 3D-Interchange Files with the Screen Viewer on a laptop or desktop computer, a projector that projects the content of the computer's display screen on a large projection surface can be used. This non-immersive alternative for large audiences is very effective and most affordable (the required projector is standard office equipment).

Alternatively, the CAVE Program running on a more powerful CAVE computer (and displaying a more detailed version of a play) can also be used for large screen projection. In principle, the setup corresponds to a CAVE with only one wall or with two or three walls connected to each other to create a wider field of view. The audience could wear shutter glasses to see the play in stereo. However, as with the CAVE, the stereo projection is only correct for a “leading” member of the audience or for an assumed average viewer sitting at the center of the auditorium. Alternatively, stereo projection can be turned off and the play is projected in monoscopic mode.

If stereo is turned on, the large screen projection system approaches a fully immersive system, especially if used for a single viewer (trainee) equipped with shutter glasses, motion tracker, and allowed to move freely in front of the projection surface or surfaces. This setup can be developed as a cost-effective alternative to a CAVE system. For three projection surfaces, the two side surfaces can be placed at an angle with the center surface to further increase the field of view and, thereby, improve the immersive experience. In addition, the CAVE computer can be replaced by a cluster of networked desktop computers to reduce the cost even more. Such “PC-driven” immersive systems have already been developed and are expected to be commercially available in the near future.

Creating Virtual Plays from Video Capture

The Chart Editor supports the creation of plays from playbook information, but can also be used to create a virtual play from video recordings.

While watching the video footage of a real play, the user can enter the path of the players and other information in the Chart Editor program and, thereby, reproduce the play for the embodiment of the invention. In principle, this is possible, but very difficult.

Using a set of video cameras covering the entire field, the movements of the players can be tracked automatically with image processing software. Such technologies exist already. The trajectories of the players can be directly fed into the Chart Editor and a virtual reproduction of the play can be generated quickly. Once the play is created, the embodiment allows one to observe the play from any location on the field or to move with a selected player, something a real camera is usually not permitted to do during a game.

This feature not only allows for the quick creation of new plays for the Play Library, it also is of high interest during the television broadcast of a game for immediate play analysis. The replay of actions on the field can be enhanced by virtual replays with more revealing viewpoints and interesting movements of the virtual camera.

Appendix A of this application is entitled “Ched (Chart Editor)-Documentation” and provides additional details of one embodiment of the invention and how to make and use it. This program illustrates how a part of the invention could be implemented. It is a prototype or test version that actually works and proves the feasibility of the invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

[image]

[image]

[image]

[image]

[image]

[image]

[image]

[image]

[image]

[image]

[image]

[image]

[image]

[image]

What is claimed is:

1. A method for creating an animated 3-D scenario, the method comprising:
receiving data which represent humans and positions and paths of the humans; and
automatically creating an animated 3-D scenario including 3-D animated virtual humans moving along virtual paths based on the data.

2. The method of claim 1, wherein the scenario is a play and the virtual humans are virtual players.

3. The method of claim 2, wherein the virtual players are virtual football players.

4. The method as claimed in claim 1, wherein the data represents a 2-D chart.

5. The method as claimed in claim 4, wherein the 2-D chart is a play chart.

6. The method as claimed in claim 1 further comprising editing the data to obtain edited data wherein the step of creating is based on the edited data.

7. The method of claim 1, wherein the step of creating includes the step of determining interactions between the virtual humans based on the paths.

8. The method of claim 7, wherein the step of creating further includes determining virtual motions for the virtual humans involved in the determined interactions.

9. The method of claim 1 further comprising creating a virtual environment and simulating the animated 3-D scenario in the virtual environment.

10. The method of claim 9 further comprising controlling the animated 3-D scenario in the virtual environment.

11. The method of claim 10 wherein the step of controlling includes the step of controlling a view point of a real human viewing the animated 3-D scenario.

12. The method of claim 1 further comprising automatically creating a file containing the animated 3-D scenario.

13. The method of claim 12, wherein the file is a VRML file.

14. The method of claim 12 further comprising distributing the file.

15. The method of claim 14 wherein the step of distributing is performed over a computer network.

16. The method of claim 9, wherein the virtual environment is at least partially immersive.

17. The method of claim 9, wherein the virtual environment is non-immersive.

18. A system for creating an animated 3-D scenario, the system comprising:
means for receiving data which represent humans and positions and paths of the humans; and
means for automatically creating an animated 3-D scenario including 3-D animated virtual humans moving along virtual paths based on the data.

19. The system of claim 18, wherein the scenario is a play and the virtual humans are virtual players.

20. The system of claim 19, wherein the virtual players are virtual football players.

21. The system as claimed in claim 18, wherein the data represents a 2-D chart.

22. The system as claimed in claim 21, wherein the 2-D chart is a play chart.

23. The system as claimed in claim 18 further comprising means for editing the data to obtain edited data wherein the means for creating creates the animated 3-D scenario based on the edited data.

24. The system of claim 18, wherein the means for creating includes means for determining interactions between the virtual humans based on the paths.

25. The system of claim 24, wherein the means for creating further includes means for determining virtual motions for the virtual humans involved in the determined interactions.

26. The system of claim 18 further comprising means for creating a virtual environment and means for simulating the animated 3-D scenario in the virtual environment.

27. The system of claim 26 further comprising means for controlling the animated 3-D scenario in the virtual environment.

28. The system of claim 27 wherein the means for controlling controls a view point of a real human viewing the animated 3-D scenario.

29. The system of claim 18 further comprising means for automatically creating a file containing the animated 3-D scenario.

30. The system of claim 29, wherein the file is a VRML file.

31. The system of claim 29 further comprising means for distributing the file.

32. The system of claim 31 wherein the means for distributing is a computer network.

33. The system of claim 26, wherein the virtual environment is at least partially immersive.

34. The system of claim 26, wherein the virtual environment is non-immersive.

35. A computer program product comprising a computer readable medium, having thereon:
computer program code means, when the program is loaded, to make the computer execute procedure:
to receive data which represent humans and positions and paths of the humans; and
to automatically create an animated 3-D scenario including 3-D animated virtual humans moving along virtual paths based on the data.

36. The product of claim 35, wherein the scenario is a play and the virtual humans are virtual players.

37. The product of claim 36, wherein the virtual players are virtual football players.

38. The product as claimed in claim 35, wherein the data represents a 2-D chart.

39. The product as claimed in claim 38, wherein the 2-D chart is a play chart.

40. The product as claimed in claim 35 wherein the code means further makes the computer execute procedure to edit the data to obtain edited data wherein the animated 3-D scenario is automatically created based on the edited data.

41. The product of claim 35, wherein the code means further makes the computer execute procedure to determine interactions between the virtual humans based on the paths.

42. The product of claim 41, wherein the code means further makes the computer execute procedure to determine virtual motions for the virtual humans involved in the determined interactions.

43. The product of claim 35 wherein the code means further makes the computer execute procedure to create a virtual environment and to simulate the animated 3-D scenario in the virtual environment.

44. The product of claim 43 wherein the code means further makes the computer execute procedure to control the animated 3-D scenario in the virtual environment.

45. The product of claim 44 wherein the code means further makes the computer execute procedure to control a view point of a real human viewing the animated 3-D scenario.

46. The product of claim 35 wherein the code means further makes the computer execute procedure to automatically create a file containing the animated 3-D scenario.

47. The product of claim 46, wherein the file is a VRML file.

48. The product of claim 46 wherein the code means further makes the computer execute procedure to distribute the file.

49. The product of claim 48 wherein the distributing is performed over a computer network.

50. The product of claim 43, wherein the virtual environment is at least partially immersive.

51. The product of claim 43, wherein the virtual environment is non-immersive.
